(19) United States
(12) Patent Application Publication
(10) Pub. No.: US 2013/0188071 A1
(43) Pub. Date: Jul. 25, 2013

(54) ELECTRONIC APPARATUS AND PHOTOGRAPHY CONTROL METHOD

(71) Applicant: SANYO ELECTRIC CO., LTD., Moriguchi City (JP)

(72) Inventor: Hideto Fujita, Yao City (JP)

(73) Assignee: SANYO ELECTRIC CO., LTD., Moriguchi City (JP)

(21) Appl. No.: 13/709,821

(22) Filed: Dec. 10, 2012

(30) Foreign Application Priority Data
Jan. 25, 2012 (JP) 2012-013174

(51) Int. Cl. H04N 5/232

(52) U.S. Cl. CPC H04N 5/232
USPC 348/222.1

(57) ABSTRACT

An electronic apparatus includes an image pickup portion for generating a subject image signal by photography, a hardware device for controlling optical characteristics in the photography, a software executing portion for executing camera application software for performing the photography, and a control portion for controlling the hardware device. When the camera application software executed by the software executing portion is specific software that does not contain a program for controlling the optical characteristics, the control portion controls the optical characteristics independently of the specific software.

### CROSS-REFERENCE TO RELATED APPLICATIONS

This nonprovisional application claims priority under 35 U.S.C. §119(a) on Patent Application No. 2012-013174 filed in Japan on Jan. 25, 2012, the entire contents of which are hereby incorporated by reference.

### BACKGROUND OF THE INVENTION

1. Field of the Invention

The present invention relates to an electronic apparatus and a photography control method.

2. Description of Related Art

Mobile terminals (mobile information terminals) equipped with an operating system, such as iPhone (registered trademark) and an Android terminal (registered trademark) have become rapidly widespread. In these mobile terminals, application software available publicly on the network is installed so that desired functions can be added. In addition, in these mobile terminals, because information for developing application software is open to public, many application software developers have developed and released various innovative application software. In particular, because hardware specification is opened to public for Android (registered trademark), many manufacturers have released mobile terminals equipped with the Android (registered trademark) to the market. Further, there are also on the market television receivers, music players, digital cameras, and the like, equipped with Android (registered trademark). On the other hand, the above-mentioned mobile terminals are usually equipped with a camera function, and many camera application software programs for utilizing the camera function are developed and are opened to public.

However, at present, a lens of a camera incorporated in a mobile terminal is usually a fixed magnification lens. Therefore, camera application software available in public usually has no function to control optical zoom. Similarly, because not many mobile terminals include an optical member for realizing optical shake correction, there is no camera application software for controlling optical shake correction, as a result. On the other hand, for a digital camera (a digital still camera or a digital video camera), it is common to mount an optical zoom function and an optical shake correction function.

If the above-mentioned public domain camera application software can be installed and used in the electronic apparatus capable of functioning as a digital camera, it is beneficial for a user. However, when the photography control is performed under the above-mentioned public domain camera application software, because the software has no optical member control function, even if the electronic apparatus has an optical member for optical zoom or optical shake correction, the optical zoom or the like does not work. It is not desired that the inherently feasible function cannot be used. Although the optical zoom and the optical shake correction are exemplified above as the inherently feasible function, the same is true for other functions.

### SUMMARY OF THE INVENTION

An electronic apparatus according to the present invention includes an image pickup portion which generates an image signal of a subject by photography, a hardware device which controls optical characteristics in the photography, a software executing portion which executes camera application software for performing the photography, and a control portion which controls the hardware device. If the camera application software executed by the software executing portion is specific software that does not contain a program for controlling the optical characteristics, the control portion controls the optical characteristics independently of the specific software.

A photography control method according to the present invention is a method for controlling photography used for an electronic apparatus including an image pickup portion for generating an image signal of a subject by photography and a hardware device for controlling optical characteristics in the photography. If the camera application software executed for performing the photography is specific software that does not contain a program for controlling the optical characteristics, the method includes controlling the optical characteristics independently of the specific software by using the hardware device.

### BRIEF DESCRIPTION OF THE DRAWINGS

FIG. 1 is a general schematic block diagram of an electronic apparatus according to an embodiment of the present invention.

FIG. 2 is a hierarchical structure diagram of a system of the electronic apparatus according to the embodiment of the present invention.

FIG. 3 is a detailed hierarchical structure diagram of the system of the electronic apparatus according to the embodiment of the present invention.

FIG. 4 is a diagram illustrating a structure of camera control software.

FIG. 5 is a diagram illustrating a control flow when the camera application software is executed.

FIG. 6 is a diagram illustrating a control flow when the camera application software is executed.

FIG. 7 is a diagram illustrating a control flow when the camera application software is executed.

### DETAILED DESCRIPTION OF THE PREFERRED EMBODIMENTS

Hereinafter, an example of an embodiment of the present invention is described in detail with reference to the drawings. In the drawings to be referred to, the same parts are denoted by the same numerals or symbols, and hence overlapping description of the same part is omitted as a rule. Note that in this specification, for simple description, when using numeral or symbol indicating information, a signal, physical quantity, state quantity, or a member, a name of the information, the signal, the physical quantity, the state quantity, or the member corresponding to the numeral or the symbol may be omitted or abbreviated. In addition, in this embodiment, software and program have the same meaning.

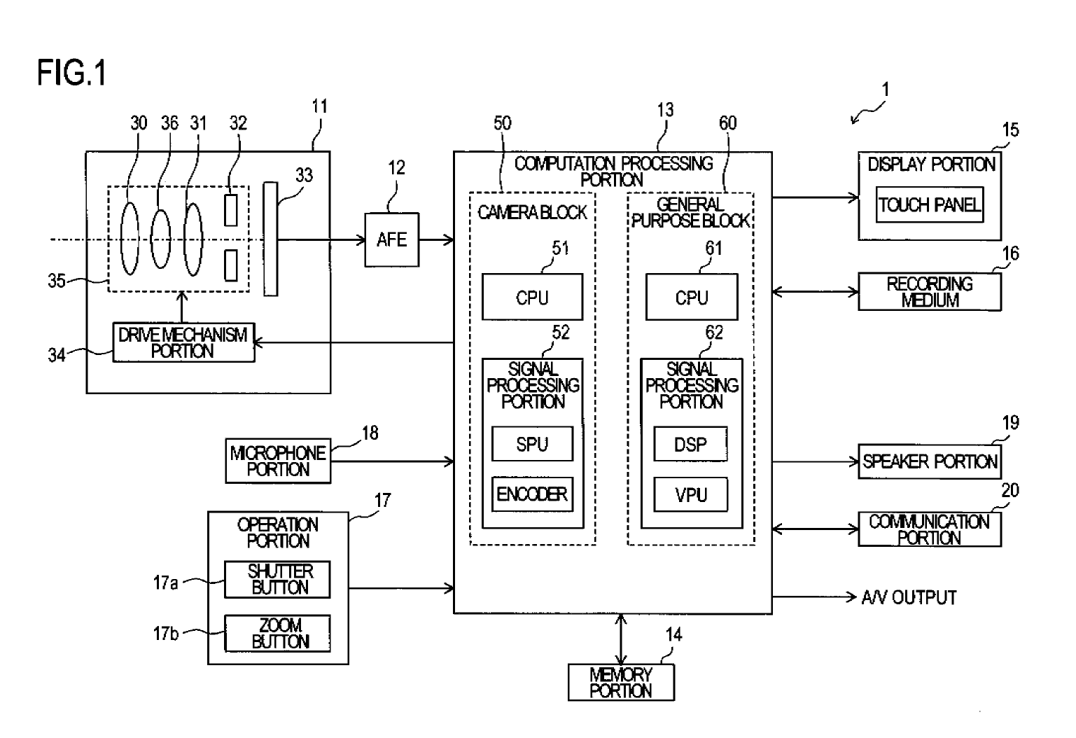

FIG. 1 is a general schematic block diagram of an electronic apparatus 1 according to the embodiment of the present invention. The electronic apparatus 1 includes individual portions denoted by numerals 11 to 20. Because the electronic apparatus 1 has a photography function, the electronic apparatus 1 can be called an image pickup apparatus (a digital camera). The image pickup apparatus is one type of the electronic apparatus. The electronic apparatus 1 may have other functions than the photography function (for example, a telephone function, an Internet connection function, an electronic mail transmission/reception function, and a music reproduction function). In this case, the electronic apparatus 1 can be classified into equipment other than the image pickup apparatus (for example, a mobile telephone or an information terminal).

The image pickup portion 11 performs photography of a subject by using an image sensor 33. The image pickup portion 11 includes an optical system 35, the image sensor (solid-state image sensor) 33 constituted of a charge coupled device (CCD) or a complementary metal oxide semiconductor (CMOS) image sensor, and a drive mechanism portion 34 which drives and controls the optical system 35. The optical system 35 is constituted of a plurality of lenses including a zoom lens 30 which adjusts angle of view (namely, an optical zoom magnification) of the image pickup portion 11, a focus lens 31 which adjusts focus, and a correction lens 36 which performs shake correction, and further includes an aperture stop 32. The zoom lens 30 and the focus lens 31 can move in an optical axis direction. The correction lens 36 can move in a plane perpendicular to the optical axis. Under control of an computation processing portion 13, a position of the zoom lens 30, a position of the focus lens 31, a position of the correction lens 36, and an opening degree of the aperture stop 32 (namely, aperture stop value) in the optical system 35 are adjusted by a drive mechanism portion 34 constituted of a motor and the like. The image sensor 33 performs photoelectric conversion of an optical image of a subject entering through the optical system 35, and outputs an electric signal obtained by the photoelectric conversion, namely an image signal of the subject to an AFE 12. The analog front end (AFE) 12 amplifies an analog image signal output from the image pickup portion 11 (image sensor 33), converts the amplified image signal into a digital image signal, and outputs the digital image signal to the computation processing portion 13. An amplification degree of the signal amplification in the AFE 12 is controlled by the computation processing portion 13.

The computation processing portion 13 works as a main control portion and integrally controls actions of individual portions in the electronic apparatus 1. The computation processing portion 13 can be constituted of an integrated circuit. The computation processing portion 13 includes a camera block 50 related to realizing the photography function and a general purpose block 60 related to realizing functions other than the photography function. The camera block 50 includes a central processing unit (CPU) 51 which mainly performs a program for realizing the photography function and a signal processing portion 52 which performs various signal processing (such as a noise reduction process, a demosaicing process, a color correction process, an edge enhancement process, and a signal compression process) on the image signal from the AFE 12. The signal processing portion 52 includes, for example, a signal processing unit (SPU), and an encoder which compresses the image signal in accordance with an arbitrary signal compression standard such as Moving Picture Experts Group (MPEG) or Joint Photographic Experts Group (JPEG). The general purpose block 60 includes a CPU 61 which executes an arbitrary program, and a signal processing portion 62 which performs various signal processing in the functions of the general purpose block 60 (for example, the telephone function, the Internet connection function, the electronic mail transmission/reception function, and the music reproduction function). The signal processing portion 62 includes, for example, a digital signal processor (DSP) and a visual processing unit (VPU) including a video decoder.

A memory portion 14 is constituted of a semiconductor memory, and includes a program memory for storing various programs executed by the CPU 51 and the CPU 61, and a data memory for temporarily storing arbitrary data generated and used in the computation processing portion 13.

A display portion 15 is a display device having a display screen such as a liquid crystal display panel, and displays an arbitrary image under control of the computation processing portion 13. The display portion 15 is equipped with a touch panel, and hence a user can issue various instructions to the electronic apparatus 1 by touching the display screen of the display portion 15 with a touching member (such as a finger or a touch pen). However, the touch panel can be eliminated. A recording medium 16 is a nonvolatile memory such as a card-like semiconductor memory or a magnetic disk, and stores arbitrary data including the image signal under control of the computation processing portion 13. An operation portion 17 includes a shutter button 17a for accepting an instruction to take a still image, a zoom button 17b for accepting an instruction to change zoom magnification, and the like, and hence various operations of the user can be accepted. An operation content with the operation portion 17 is transmitted to the computation processing portion 13. The shutter button 17a and the zoom button 17b may be buttons on the touch panel.

A microphone portion 18, which is constituted of one or more microphones, converts ambient sound around the electronic apparatus 1 (containing voice of the user as a speaker) into a sound signal, and outputs the obtained sound signal to the computation processing portion 13. When the electronic apparatus 1 takes a moving image, the sound signal can be recorded together with the image signal in the recording medium 16. A speaker portion 19 reproduces the arbitrary sound signal and outputs the sound. A communication portion 20 performs wired or wireless communication with an arbitrary apparatus (not shown) except the electronic apparatus 1 in accordance with an arbitrary bus standard (for example, USB (registered trademark) standard) or communication standard (for example, Wi-Fi (registered trademark) or Bluetooth (registered trademark)). In addition, the computation processing portion 13 can output an arbitrary video signal and sound signal as a digital or analog signal to an external apparatus (for example, a television receiver) of the electronic apparatus 1. The image signal is one type of the video signal. Note that the electronic apparatus 1 may be further equipped with an arbitrary component that is not shown in FIG. 1 (for example, an electronic flash, and a position location module using a Global Positioning System (GPS)).

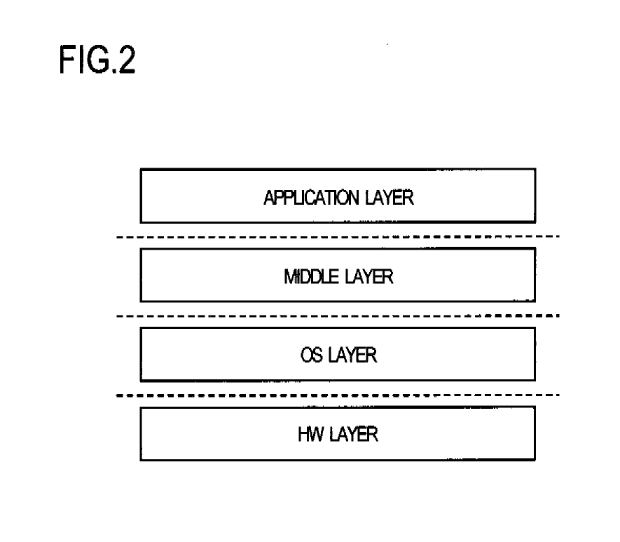

FIG. 2 illustrates a hierarchical structure of a system of the electronic apparatus 1, which is constituted of hardware and software. A system of the electronic apparatus 1 includes an HW layer constituted of various hardware devices, an OS layer of software called an operating system or fundamental software, a middle layer of software called libraries having high general-purpose properties, and an application layer of various application software programs. The application software works on the fundamental software in the OS layer, and uses the libraries and the like appropriately for permitting various hardware devices in the HW layer to work via driver software programs in the OS layer so as to realize the various functions.

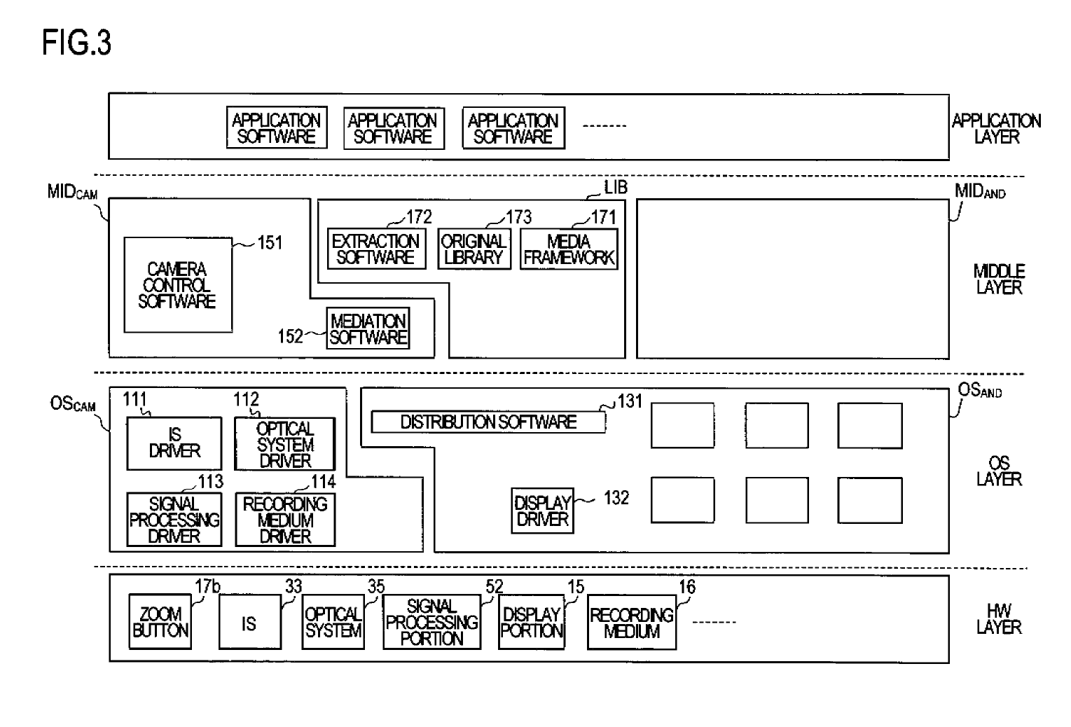

FIG. 3 illustrates an example of a more specific hierarchical structure of the system of the electronic apparatus 1. The HW layer is constituted of various hardware devices in the electronic apparatus 1. In FIG. 3, as a part of the hardware devices in the electronic apparatus 1, there are illustrated the zoom button 17b, the image sensor (IS) 33, the optical system 35, the signal processing portion 52, the display portion 15, and the recording medium 16.

In the OS layer of the electronic apparatus 1, there are disposed fundamental software OS_{CAM} and OS_{AND}. Each of the fundamental software OS_{CAM} and OS_{AND} corresponds to the so-called operating system. The fundamental software OS_{CAM} can be executed to work on the CPU 51, and the fundamental software OS_{AND} can be executed to work on the CPU 61. In the electronic apparatus 1, two CPUs 51 and 61 are used so that two operating systems, namely the fundamental software OS_{CAM} and OS_{AND} can work in parallel (namely, can work simultaneously and independently). Note that it is possible to operate three or more operating systems in parallel in the electronic apparatus 1.

The fundamental software OS_{CAM} may be an operating system developed for the electronic apparatus 1. In contrast, the fundamental software OS_{AND} is an operating system that is used in various electronic apparatuses including the electronic apparatus 1 for a general purpose use, and may be an operating system by Android (registered trademark), for example. The fundamental software OS_{AND} is an operating system of which information necessary for developing application software working on the fundamental software OS_{AND} is open to public like the operating system by Android (registered trademark). The information to be open to public may contain source codes of the fundamental software OS_{AND}, and the fundamental software OS_{AND} may be so-called open-source software. To be open to public of information or software means that the information or the software is widely open to public via a network such as the Internet, recording media, or the like, freely or for a charge.

The fundamental software OS_{CAM} contains a plurality of device drivers for the hardware devices in the HW layer. The device driver means software for operating and controlling the hardware device in the HW layer. The device drivers in the fundamental software OS_{CAM} contains an IS driver 111, an optical system driver 112, a signal processing driver 113, and a recording medium driver 114. The IS driver 111 performs read control of the image signal from the image sensor 33, frame rate control of moving image photography using the image sensor 33, and the like. The optical system driver 112 controls and changes the optical zoom magnification in the photography by performing control and change of position of the zoom lens 30, controls and changes a focus state of the subject in the photography by performing control and change of position of the focus lens 31, controls and changes a position of the subject on the image sensor 33 by performing control and change of position of the correction lens 36, and controls and changes incident light intensity to the image sensor 33 by performing control and change of the opening degree of the aperture stop 32. The optical system driver 112 operates the drive mechanism portion 34 (see FIG. 1) so as to realize control of the positions of the individual lenses and control of the opening degree of the aperture stop 32. The signal processing driver 113 is software for operating the signal processing portion 52, and the recording medium driver 114 is software for controlling data record in the recording medium 16 and data read from the recording medium 16.

The fundamental software OS_{AND} also contains a plurality of device drivers for the hardware devices in the HW layer. The device drivers in the fundamental software OS_{AND} include, in addition to a display driver 132, device drivers for the hardware devices for realizing functions other than the photography function (for example, the above-mentioned telephone function, and the like). The display driver 132 in the fundamental software OS_{AND} controls display content of the display portion 15 via control of the VPU or the like in the signal processing portion 62. Distribution software 131 will be described later. Note that the recording medium driver 114 may be disposed not in the fundamental software OS_{CAM} but in the fundamental software OS_{AND}.

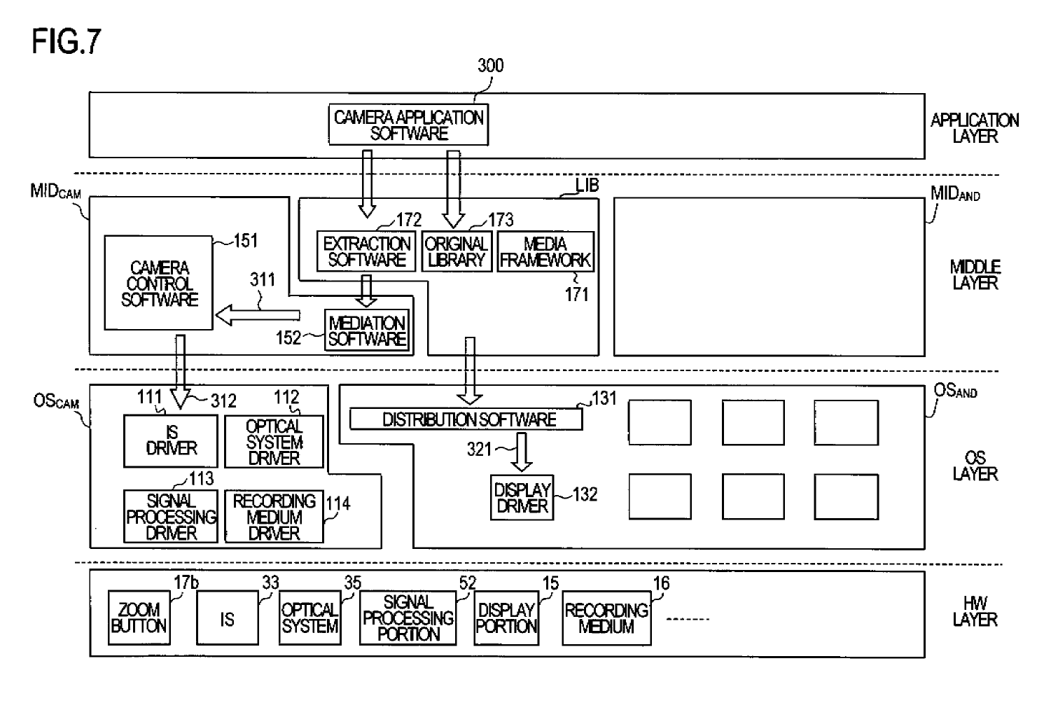

The middle layer is roughly divided into a middle block MID_{CAM} which mainly functions as a middle layer for the fundamental software OS_{CAM}, a middle block MID_{AND} which mainly functions as a middle layer for the fundamental software OS_{AND}, and a library block LIB. The middle block MID_{CAM} contains camera control software 151 and mediation software 152. Each software in the middle block MID_{CAM} works on the fundamental software OS_{CAM}. The library LIB contains a media framework 171, extraction software 172, and an original library 173. The media framework 171 is a library (software) having high general-purpose properties for controlling signal processing content on the image signal and the sound signal. The original library 173 is a library used in application software 300 (see FIG. 7) that will be described later. The middle block MID_{AND} contains various libraries working on the fundamental software OS_{AND}. The libraries in the media framework 171 and the middle block MID_{AND} may be libraries provided by Android (registered trademark). Each software program in the middle block MID_{CAM} can be executed by the CPU 51 to work, and each software program in the middle block MID_{AND} can be executed by the CPU 61 to work. Each software program in the library LIB can be executed by the CPU 51 or 61 to work.

Here, in the electronic apparatus 1, optical zoom and optical shake correction can be realized. The optical zoom means a function of controlling and changing an optical zoom magnification in the photography (namely, an angle of view of the photography using the image pickup portion 11). The control and change of the optical zoom magnification is realized by control and change of a position of the zoom lens 30 using the optical system driver 112. The optical shake correction means a function of suppressing a shake (blur) of a subject on a photographed image due to movement of the electronic apparatus 1 (movement of the body of the electronic apparatus 1). The photographed image means a subject image obtained by photography using the image pickup portion 11 (namely, a moving image or a still image based on an output image signal of the image sensor 33). The above-mentioned suppression of shake is realized by controlling a position of the correction lens 36 via the optical system driver 112 based on movement data indicating a state of movement of the electronic apparatus 1. The electronic apparatus 1 can acquire movement data based on a detection result of a movement sensor for detecting movement of the electronic apparatus 1 (for example, an acceleration sensor or an angular acceleration sensor) or based on an optical flow based on an output image signal of the image sensor 33.

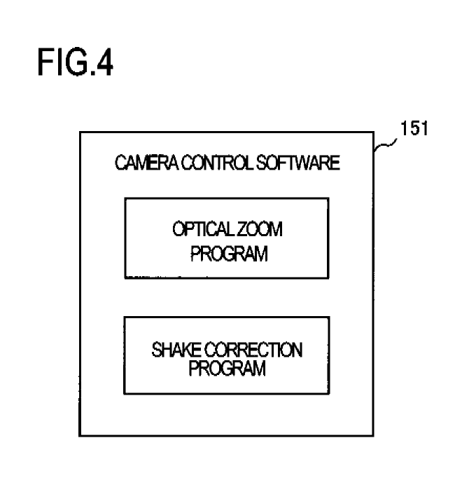

The camera control software 151 contains an optical zoom program for realizing optical zoom and a shake correction program for realizing optical shake correction (see FIG. 4). When the user performs a zoom operation for instructing increase or decrease of the optical zoom magnification to the zoom button 17b, the optical zoom program generates a zoom lens movement instruction defining movement direction and movement amount of the zoom lens 30 based on the zoom operation content and gives the instruction to the optical system driver 112. Then, the optical system driver 112 changes a position of the zoom lens 30 in accordance with the zoom lens movement instruction, and hence increase or decrease of the optical zoom magnification is realized. The shake correction program determines movement direction and movement amount of the correction lens 36 for canceling the above-mentioned shake based on the above-mentioned movement data, and gives a correction lens movement instruction defining the obtained movement direction and movement amount to the optical system driver 112. Then, the optical system driver 112 changes the position of the correction lens 36 corresponding to the correction lens movement instruction, and hence the above-mentioned shake is suppressed.

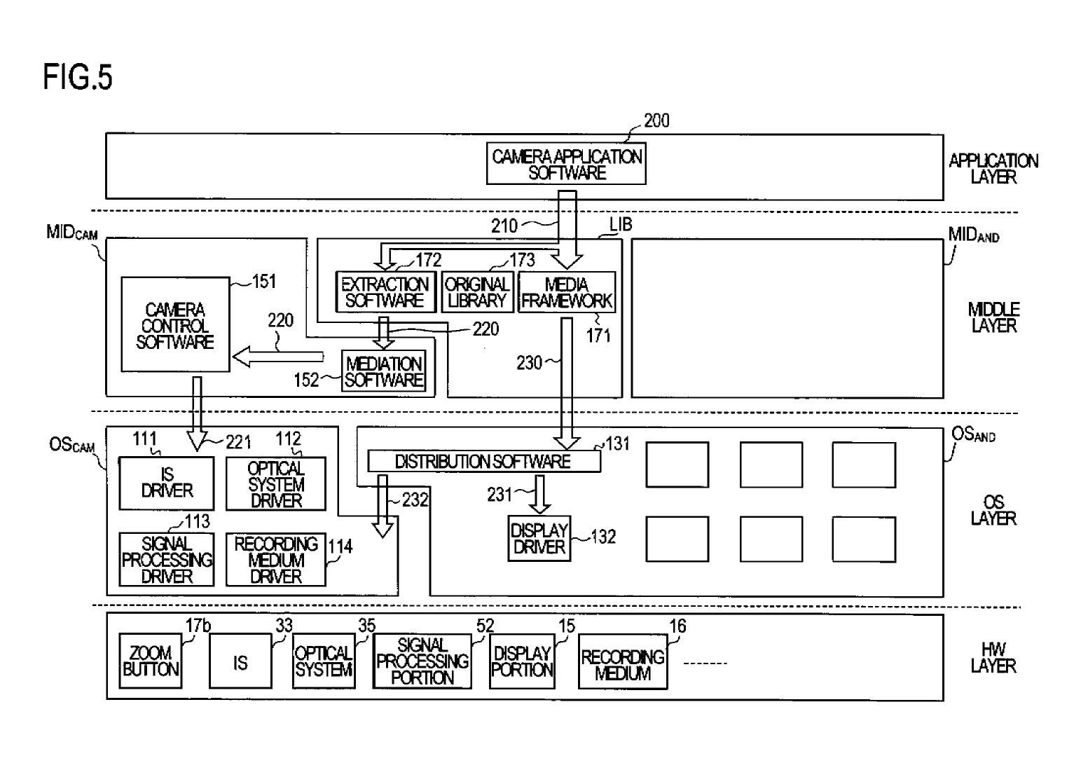

As described above, because the fundamental software OS_{AND} is a public domain operating system, it is expected that various application software working on the fundamental software OS_{AND} will become available, and the user of the electronic apparatus 1 can obtain various application software working on the fundamental software OS_{AND} and can operate them on the electronic apparatus 1. Actually, for example, many application software programs working on electronic devices classified into a smart phone are available. Software 200 in FIG. 5 is an example of camera application software that can be installed in the electronic apparatus 1. The camera application software is application software for performing control of photography (application software for acquiring and recording a photographed image). The software 200 is public domain software available in an arbitrary market, for example.

Devices such as a smart phone other than the electronic apparatus 1 may not be equipped with an optical zoom function and an optical shake correction function in many cases. Therefore, the camera application software (except the software 300 illustrated in FIG. 7 described later) is usually designed in supposition that the software is installed in a smart phone that cannot realize the optical zoom function and the optical shake correction function, or without consideration of presence or absence of the optical zoom function and the optical shake correction function. As a result, it is supposed that the software 200 does not contain the program for realizing the optical zoom function and the optical shake correction function. In other words, the software 200 does not contain a program that responds to the zoom operation corresponding to the zoom button 17b, and does not contain a program for determining a movement amount of the correction lens 36, etc., in accordance with the above-mentioned movement data.

With reference to FIG. 5, a control flow when the application software 200 is executed is described. The software 200 works on the fundamental software OS_{AND}. The software 200 transmits an instruction 210 to the library block LIB (and further to the middle block MID_{AND} as necessary) so that a predetermined action is realized on the electronic apparatus in which the software 200 is installed. The instruction 210 contains, for example, a photographed image acquisition instruction for acquiring a photographed image from the output image signal of the image sensor, an image processing instruction for performing a predetermined image processing on the photographed image, a record instruction for recording an image before or after the image processing in the recording medium in the electronic apparatus, a display instruction for displaying video based on the photographed image on the display portion of the electronic apparatus, and the like. Therefore, when the electronic apparatus 1 performs the software 200, photography of a subject by using the image sensor 33 is performed, and the image signal of the photographed image can be recorded in the recording medium 16.

The extraction software 172 extracts a part of the instruction 210 as an instruction 220. The extracted instruction 220 is given to the camera control software 151 via the mediation software 152. The camera control software 151 gives an instruction 221 according to the instruction 220 to each device driver in the fundamental software OS_{CAM} so as to permit each hardware device in the HW layer to realize an action according to the instruction 220. On the other hand, based on an instruction other than the instruction 220 in the instruction 210, the media framework 171 generates an instruction 230. The instruction 230 is transmitted from the media framework 171 to the distribution software 131. The distribution software 131 divides the instruction 230 into an instruction 231 to be realized by using the display driver 132 in the fundamental software OS_{AND} and an instruction 232 to be realized by using the device driver in the fundamental software OS_{CAM}. The instruction 231 is transmitted to the display driver 132. As a result, the display corresponding to the instruction 231 is performed by the display portion 15. The instruction 232 is transmitted to the device driver in the fundamental software OS_{CAM}. As a result, an action corresponding to the instruction 232 (for example, a recording action by the recording medium 16 using the recording medium driver 114) is realized. As understood from the above description, the device driver in the fundamental software OS_{CAM} works based on the instructions 221 and 232. It is preferable that the instructions to the IS driver 111 and the optical system driver 112 should be contained not in the instruction 232 but in the instruction 221. The instruction 230 contains at least an instruction concerning display. If the instruction 230 contains only the instruction concerning display, the instruction 232 is omitted.

[Independent Control of Optical Zoom]

If the camera application software executed by the computation processing portion 13 does not contain the program for realizing the optical zoom, the camera control software 151 can contain the above-mentioned zoom lens movement instruction by the optical zoom program in the instruction 221 without depending on the camera application software executed by the computation processing portion 13.

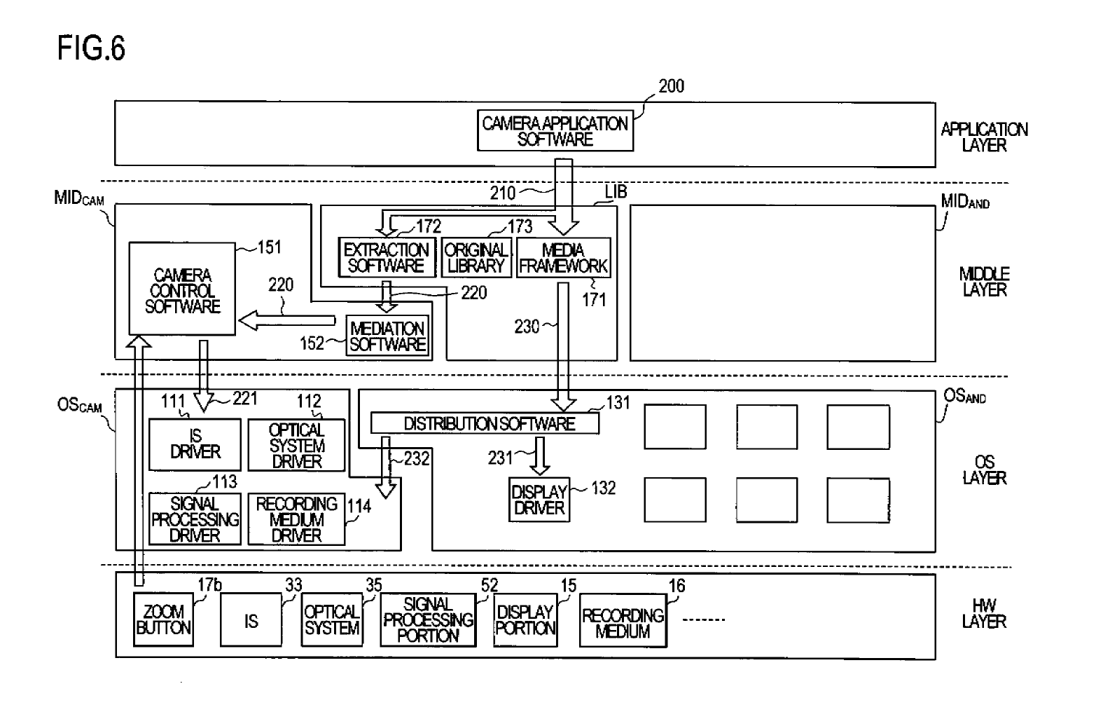

In other words, when the software 200 is working on the fundamental software OS_{AND}, the camera control software 151 executes the optical zoom program independently of the software 200 and the fundamental software OS_{AND} so as to accept the user's zoom operation, and hence can generate the zoom lens movement instruction according to the zoom operation and can contain the instruction in the instruction 221 when the zoom operation is performed (see FIG. 6). As a result, in the electronic apparatus 1, the optical system driver 112 and the zoom lens 30 can work independently of the software 200 and the fundamental software OS_{AND}, so as to realize the optical zoom independently of the software 200 and the fundamental software OS_{AND}.

[Independent Control of Optical Shake Correction]

In addition, if the camera application software executed by the computation processing portion 13 does not contain the program for realizing the optical shake correction, the camera control software 151 can contain the above-mentioned correction lens movement instruction by the shake correction program in the instruction 221 without depending on the camera application software executed by the computation processing portion 13.

In other words, when the software 200 is working on the fundamental software OS_{AND}, the camera control software 151 executes the shake correction program independently of the software 200 and the fundamental software OS_{AND}, and hence can generate the correction lens movement instruction and can contain the correction lens movement instruction in the instruction 221. As a result, in the electronic apparatus 1, the optical system driver 112 and the correction lens 36 work independently of the software 200 and the fundamental software OS_{AND}, and hence the optical shake correction can be realized independently of the software 200 and the fundamental software OS_{AND}.

Note that it is possible to dispose a variable angle prism (not shown) for refracting incident light from a subject in the optical system 35 instead of the correction lens 36, and to change a refraction angle of the variable angle prism instead of movement of the correction lens 36, so as to realize the optical shake correction. Alternatively, it is possible to eliminate the correction lens 36 and to move the image sensor 33 in a plane perpendicular to the optical axis instead of the correction lens 36, so as to realize the optical shake correction.

[Independent Control of Focus Adjustment]

The hardware device that can be controlled independently of the software 200 and the fundamental software OS_{AND} is not limited to the zoom lens 30 and the correction lens 36 (or the variable angle prism and the like). For instance, if the camera application software executed by the computation processing portion 13 does not contain a program for realizing the focus adjustment, the camera control software 151 may execute the focus adjustment program without depending on the camera application software executed by the computation processing portion 13 so as to contain an instruction for the focus lens in the instruction 221. The focus adjustment program can be contained in the camera control software 151.

In other words, if the software 200 does not contain the program for performing the focus adjustment and is working on the fundamental software OS_{AND}, the camera control software 151 can execute the focus adjustment program independently of the software 200 and the fundamental software OS_{AND}, so as to generate the instruction for the focus lens and to contain the instruction for the focus lens in the instruction 221. As a result, in the electronic apparatus 1, the optical system driver 112 and the focus lens 31 can work independently of the software 200 and the fundamental software OS_{AND}, and hence the focus adjustment can be realized independently of the software 200 and the fundamental software OS_{AND}.

The focus adjustment program determines a position of the focus lens 31 for focusing on the subject image on the image sensor 33 as an in-focus lens position, based on an output image signal of the image sensor 33 or based on a measurement result of a distance measuring sensor (not shown) for measuring a distance between the subject and the electronic apparatus 1. Then, the focus adjustment program issues the instruction for the focus lens to move the focus lens 31 to the determined in-focus lens position to the optical system driver 112. The optical system driver 112 adjusts the position of the focus lens 31 in accordance with the instruction for the focus lens so as to perform the focus adjustment (for obtaining the in-focus state).

[Independent Control of Aperture Stop Adjustment]

In addition, if the camera application software executed by the computation processing portion 13 does not contain a program for realizing aperture stop adjustment, the camera control software 151 mat execute an aperture stop adjustment program without depending on the camera application software executed by the computation processing portion 13 so as to contain an instruction for the aperture stop in the instruction 221. The aperture stop adjustment program can be contained in the camera control software 151.

In other words, if the software 200 does not contain the program for performing the aperture stop adjustment and is working on the fundamental software OS_{AND}, the camera control software 151 can execute the aperture stop adjustment program independently of the software 200 and the fundamental software OS_{AND} so as to generate the instruction for the aperture stop, and can contain the instruction for the aperture stop in the instruction 221. As a result, in the electronic apparatus 1, the optical system driver 112 and the aperture stop 32 work independently of the software 200 and the fundamental software OS_{AND}, and the aperture stop adjustment can be realized independently of the software 200 and the fundamental software OS_{AND}.

The aperture stop adjustment program determines an opening degree of the aperture stop 32 (aperture stop value) for maintaining brightness of the photographed image to be a desired brightness as an optimal opening degree based on the output image signal of the image sensor 33 or based on a measurement result of a photometry sensor (not shown) for measuring luminosity of a photography region of the image pickup portion 11. Then the aperture stop adjustment program issues the instruction for the aperture stop to define the optimal opening degree to the optical system driver 112. The optical system driver 112 adjusts the opening degree of the aperture stop 32 in accordance with the instruction for the aperture stop so as to maintain the incident light intensity to the image sensor 33 to be optimal value.

[Original Camera Application Software]

Next, with reference to FIG. 7, a control flow when the application software 300 is executed is described. The software 300 can work on the fundamental software OS_{AND}. The software 300 is, for example, original camera application software designed by a person or company knowing a hardware structure of the electronic apparatus 1 (for example, a person or company in charge of designing, developing, or manufacturing the electronic apparatus 1). Therefore, the designer of the application software 300 knows that the optical zoom function or the like using the optical system driver 112 and the optical system 35 can be used in the electronic apparatus 1.

Therefore, the designer of the software 300 can contain at least one of the optical zoom program, the shake correction program, the focus adjustment program, and the aperture stop adjustment program in the software 300. Otherwise, the designer can contain in the software 300 a program for instructing to execute at least one of the optical zoom program, the shake correction program, the focus adjustment program, and the aperture stop adjustment program in the camera control software 151. Thus, when the software 300 is executed in the electronic apparatus 1, it is possible to realize at least one of the optical zoom, the optical shake correction, the focus adjustment, and the aperture stop adjustment. When the software 300 is executed, an instruction 311 by the software 300 is transmitted to the camera control software 151 via the extraction software 172 and the mediation software 152, and an instruction 312 based on the instruction 311 is given to each device driver in the fundamental software OS_{CAM}. Thus, photography control containing at least one of the optical zoom, the optical shake correction, the focus adjustment, and the aperture stop adjustment can be realized. In addition, when the software 300 is executed, the original library 173 that is developed for the electronic apparatus 1 or is appropriate particularly to the electronic apparatus 1 is appropriately used, and the instruction 321 based on the software 300 is given to the display driver 132 via the distribution software 131. Thus, the display corresponding to the software 300 is performed by the display portion 15.

The zoom lens 30 driven in the optical zoom, the correction lens 36 (or the variable angle prism or the image sensor 33) driven in the optical shake correction, the focus lens 31 driven in the focus adjustment, and the aperture stop 32 driven in the aperture stop adjustment are all hardware devices for controlling optical characteristics of the image pickup portion 11 (in other words, optical characteristics in the photography). The hardware device control portion (for example, the CPU 51) included in the computation processing portion 13 can control the optical characteristics of the image pickup portion 11 by controlling the hardware device. The software executing portion (for example, the CPU 61) included in the computation processing portion 13 can selectively execute one of a plurality of camera application software for performing the photography including the software 200 and 300. The user interface constituted of the operation portion 17 and the touch panel accepts a selection operation for instructing which camera application software should be executed by the computation processing portion 13. Then, if the camera application software executed by the computation processing portion 13 (software executing portion) is specific software that does not contain a program for controlling or changing the optical characteristics (the software 200 in this embodiment), the hardware device control portion permits the device driver in the fundamental software OS_{CAM} to work independently of the fundamental software OS_{AND} and the specific software, and hence controls or changes the above-mentioned optical characteristics independently of the fundamental software OS_{AND} and the specific software.

Thus, even if the photography control is performed under the specific software, the electronic apparatus 1 can effectively use the inherently feasible function. As a result, also in the case where the specific software is used, the user can obtain a photographed image as high as the case where software developed specially for the electronic apparatus 1 is used (for example, an image having an optimal angle of view).

Note that when the specific software (the software 200 in this embodiment) is executed, it is not always necessary to perform the optical zoom, the optical shake correction, the focus adjustment, and the aperture stop adjustment. It is sufficient that the electronic apparatus 1 performs one or more arbitrary process of the optical zoom, the optical shake correction, the focus adjustment, and the aperture stop adjustment when the specific software is executed.

The embodiment of the present invention can be variously modified appropriately within the range of the technical concept described in the claims. The embodiment described above is merely an example of the embodiment of the present invention, and meanings of the present invention and each component thereof are not limited to those described in the embodiment described above. Specific values shown in the above-mentioned description are merely examples, which can be changed to various values as a matter of course.

What is claimed is:

1. An electronic apparatus comprising:
an image pickup portion which generates a subject image signal by photography;
a hardware device which controls optical characteristics in the photography;
a software executing portion which executes camera application software for performing the photography; and
a control portion which controls the hardware device, wherein
when the camera application software executed by the software executing portion is specific software that does not contain a program for controlling the optical characteristics, the control portion controls the optical characteristics independently of the specific software.

2. The electronic apparatus according to claim 1, wherein
the specific software works on fundamental software executed by the software executing portion, and
the fundamental software is an operating system whose information necessary for developing application software working on the fundamental software is open to public.

3. The electronic apparatus according to claim 2, wherein
in the software executing portion, first fundamental software as the fundamental software and second fundamental software containing a device driver for the hardware device work in parallel, and
when the camera application software executed by the software executing portion is the specific software, the control portion permits the device driver to work independently of the first fundamental software and the specific software, so as to control the hardware device.

4. The electronic apparatus according to claim 1, wherein at least one of change of the optical zoom magnification in the photography and optical shake correction for suppressing a shake of an image obtained by the photography is realized by controlling the optical characteristics.

5. The electronic apparatus according to claim 1, wherein at least one of focus adjustment in the photography and aperture stop adjustment in the photography is realized by controlling the optical characteristics.

6. A photography control method used for an electronic apparatus including an image pickup portion for generating a subject image signal by photography, and a hardware device for controlling optical characteristics in the photography, the method comprising, when camera application software executed for performing the photography is specific software that does not contain a program for controlling the optical characteristics, using the hardware device, and controlling the optical characteristics independently of the specific software.
